(19) United States
(12) Patent Application Publication
(10) Pub. No.: US 2012/0054271 A1
(43) Pub. Date: Mar. 1, 2012

(54) METHOD AND SYSTEM FOR THE REAL TIME SYNTHESIS OF INTERACTIONS RELATING TO A USER

(76) Inventors: Jean-François Leroy, Brest (FR); Rabih Abou-Chakra, Colombes (FR)

(21) Appl. No.: 13/254,420

(22) PCT Filed: Feb. 18, 2010
(86) PCT No.: PCT/FR10/50269

§ 371 Date: Nov. 14, 2011

(30) Foreign Application Priority Data
Mar. 4, 2009 (FR) 09/00968

(51) Int. Cl. G06F 15/16

(52) U.S. Cl. 709/203

(57) ABSTRACT

A method for the synthesis of a user's interactions associated with a user, characterized in that it comprises the following steps:
aggregating a user's interactions from interaction means (10, 20, 30, 41, 40) associated with a user;
identifying the users concerned by said actions;
identifying the interaction means associated with each concerned user;
recovering the information received to establish at least one interaction via the identified interaction means;
checking the availability of the identified interaction means;
caching inside the user's terminal retrieved information related to said identified users' available interaction means;

presenting interaction notifications to the user.

This invention relates to the technical field of telecommunications. Its object is a system and method for automatically managing interactions derived from multiple means of interactions associated with a user.

It more particularly relates to the synthesis of interactions managed by various means of communication and different applications, mainly computing-related, enabling a user to interact with other users or local or remote applications and to schedule or be informed of a certain operation.

The recent developments in the field of information technology have brought to light, for the benefit of the user, a great number of interaction means, such as softphones (internet telephony), e-conferences, e-mails, instant messaging, weblogs, social networking and microblogging tools, mailing lists, shared workspaces, and information management tools (personal or shared calendar, notes, schedules, address books, or more generally, personal information management).

These means have continued to grow by offering more and more user interactions. These interactions may be interactive, requiring the user's reaction (answering/calling a contact, sending/receiving data, loading/commenting on content, answering/sending an e-mail, confirming a meeting, entering/editing a reserved period of time, for example), or informative (receiving a confirmation that an e-mail has been read, receiving a notification concerning an annotated/edited piece of content or a missed call, calling back in order to perform a certain operation). These interactions are generally different in their levels of importance and urgency.

However, the techniques that are currently in use do not permit any synthesis of user interactions coming from different means of interaction. Thus, a user equipped with more than one interaction means is restricted to successively consulting all means of interaction. By way of example, a user who is a member of a shared workspace and who has an e-mail account, calendar, or softphone must unavoidably access:
his or her mailbox to consult his or her inbox;
his or her calendar in order to get information about appointments and pending or already-completed actions.
his or her softphone in order to consult his or her call history or initiate a communication, for example; and finally
with the shared workspace, for example to be informed of the latest changes to that space's content.

This requires a lot of time and computing resources, thereby risking a delay in the planned processing of an interaction. Additionally, the user must be able to reliably and frequently access the various interaction means. If the user does not, he or she might inadvertently miss one or more interactions, especially when they correspond to different interaction means and are produced at relatively close times.

Furthermore, the content of the interaction means currently available is depicted in different ways to the user, from one means to another. For example, the content of an e-mail inbox is generally arranged vertically over time while a calendar's is generally arranged horizontally over time.

Furthermore, these interaction means display the interactions, based on their objects and not on the users who are related to it, which, whenever applicable, does not encourage the establishment of a future interaction with these users.

Additionally, the current interaction means do not enable any automatic enhancement of information concerning users, which are assumed to be concerned by a single future interaction. A user must ask for his or her new contacts' contact information each time.

The current interaction means do not necessarily interfere with this. However, there are platforms which jointly support a certain (finite) number of interactions. By way of example, a forum enables the user to interact with other users via e-mail (or another interaction means) or via a piece of content loaded in the forum's platform. This solution assumes that the first interaction means already comprises the identifiers of users who follow the second means of interaction. If they don't, there is no interoperability and the various interaction means are walled off from one another. The interaction means are specifically used in this case: for example, e-mail dedicated to a text-based interaction, a softphone devoted to a voice interaction.

Personal information managers are user-oriented tools; for example, they deal with the user's to-do list, contacts, address book, and calendar. One example is the product Microsoft Office Outlook, published by Microsoft. Personal information managers has a very limited scope on a user's potential interactions. Furthermore, they do not offer any anticipation of a potential interaction of the user, in particular, when he or she is a member of a shared or collaborative workspace.

Other, database-oriented personal information managers propose tools for searching within user interactions. Windows Search and Google Desktop, respectively published by Microsoft and Google, are both examples of those personal information managers. In response to a request, they make it possible to present different user interactions (outgoing calls, e-mails, appointments, visited websites, contacts, for example) based on different criteria (type, date, author, for example). However, these tools only concern interactions that have already taken place, unlike real-time management of interactions, which could interest the user.

In order for a user to have a view that is:
comprehensive regarding his or her interactions, simultaneously including at least some of all subsequent interactions, ongoing interactions, and previous interactions;
predictive regarding his or her future actions, providing him or her with information needed to establish them; and
consistent with its interaction means and those of the users with which he or she will interact,

he or she is forced to:
simultaneously launch a plurality of interaction means (for example, Microsoft Office Outlook for e-mail, to-do list, and calendar; a softphone for voice interaction, and a shared workspace or collaborative work manager); and
request the necessary information in advance each time (telephone number, e-mail, ID, website, or uniform resource locator (URL) for example) to establish an interaction; and
checking the consistency between these interaction means, those of the users with which he or she will interact, and the information needed to establish an interaction which is at his or her disposal.

It is an object of the present invention to provide a solution to at least some of the mentioned problems by proposing a method as well of the system enabling a user to have a comprehensive summary view of his or her interactions with different levels of details,

Another object of the present invention is to enable a dynamic real-time management of interactions associated with a user.

Another object of the present invention is to encourage and, subsequently, enable the establishment of a user interaction.

Another object of the present invention is to summarize a user's interactions.

Another object of the present invention is to enable fast access to the content of a user's interactions.

Another object of the present invention is to display a user's interactions according to different criteria.

Another object of the present invention is to enable fast access to the various interaction means.

To that end, the invention pertains, according to a first aspect, to a method for a synthesis of a user's interactions associated with a user, a method which comprises the following steps:
aggregating a user's interactions, from the interaction means associated with a user;
identifying the users concerned by said actions;
identifying the interaction means associated with each concerned user;
recovering the information required to establish at least one interaction via the identified interaction means;
checking the availability of the identified interaction means;
caching inside the user's terminal retrieved information related to said identified users' available interaction means;
presenting interaction notifications to the user.

According to a second aspect, the invention pertains to a summarizer of user interactions associated with a user, which summarizer comprises:
an aggregator of user interactions drawn from means of interaction associated with the user;
a user interaction processing module;
a user interaction presentation module.

According to a third aspect, the invention pertains to a computer program product implemented on a memory medium, which may be implemented within a computer processing unit, and comprises instructions for implementing the method summarized above.

Other characteristics and advantages of the invention will become more fully apparent upon reading the description below of preferred variant embodiments of the method and preferred variant embodiments of the system, which description is made with reference to the attached figures, in which:

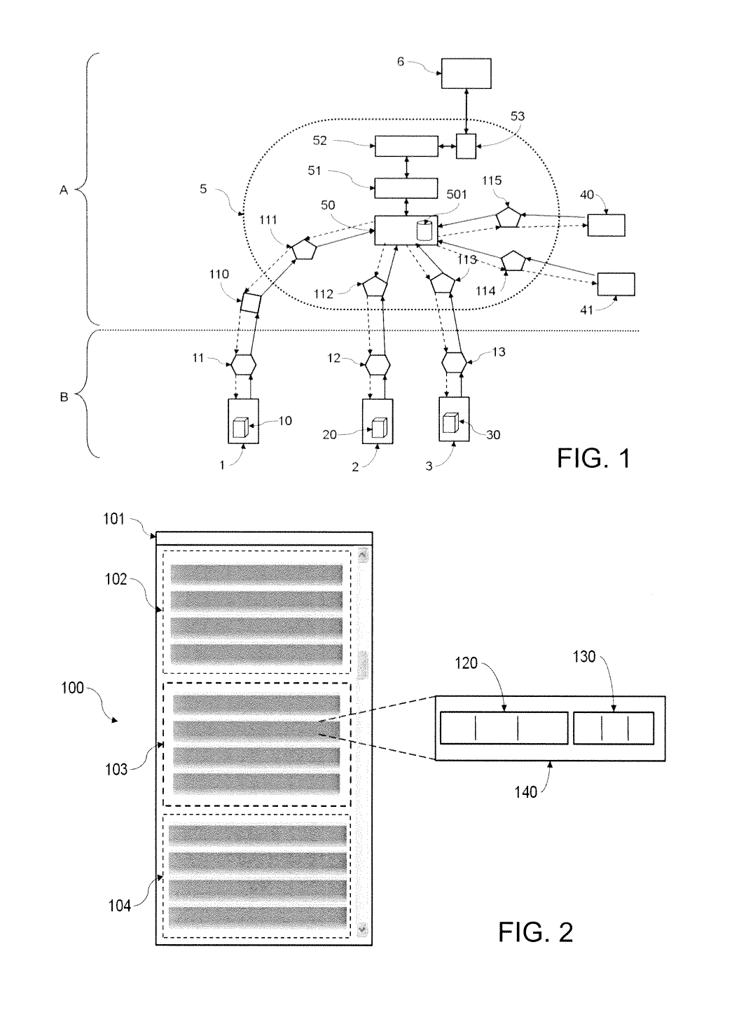

FIG. 1 represents a functional, non-limiting depiction of a system according to the invention;

FIG. 2 schematically depicts an example device according to the invention, adapted to the representation of user interactions.

The invention proposes a summarizer of user interactions, a software tool which comprises at least the following modules:
remote means of interaction 10, 20, 30 involving a client/server relationship, depicted in FIG. 1, respectively, by side A and side B;
a plurality of servers 1, 2, 3 hosting the remote means of interaction 10, 20, 30;
local means of interaction 40, 41;
an aggregator 50 of interactions;
a module for processing 51 interactions;
a presentation module 52;
client interfaces 111, 112, 113, 114, 115; and
server interfaces 11, 12, 13.

The servers 1, 2, 3 belong to platforms that enable user interactions. As nonlimiting examples of servers 1, 2, 3, an e-mail server, and instant messaging server, a network server, a printing server, an IP telephony server, and an e-conferencing server may all be mentioned.

The servers 1, 2, 3, host remote means of interaction 10, 20, 30. These means comprise, for example, an instant messaging application, a softphone application, a shared calendar application, an e-mail account, or a shared workspace.

The aggregator 50 of interactions aggregates the data of the interactions based on the various interaction means associated with the user through the intermediary of interfaces appropriate to those interaction means. To that end, two interfaces may be discerned within each link between the aggregator 50 and a server 1, 2, 3, specifically:
client interfaces 111, 112, 113 on the client side A;
server interfaces 11, 12, 13 on the server side B.

The aggregator 50 makes it possible to regularly consult all interaction means associated with a user regarding the existence of user interactions.

It should be noted that some remote interaction means 10 are associated with intermediary interaction means 110 located on the client side A. As an illustrative example, a user may interact using an e-mail interaction means via a messaging client (Lotus Notes or Microsoft Outlook, for example) which is located on the client side A. In this situation, the link established between the aggregator 50 and the server 1, which hosts the interaction means 10, comprises the intermediary interaction means 110. This ensures synchronization between the interactions aggregated by the aggregator 50, the intermediary interaction means 110, and the remote interaction means 10. It is clear that if the intermediary interaction means 110 is disabled, its presence on the aggregator 50-server 10 link will be passive.

The local interaction means 40, 41, such as a personal calendar, task list, or schedule, are located on the client side A. The aggregator 50 of interactions aggregates the interaction data drawn from the local interaction means 40, 41 associated with the user through the intermediary of client interfaces 114, 115.

The processing module 51 makes it possible to carry out processing on data describing the user interactions. This processing comprises:
identifying users concerned by interactions associated with a certain user;
identifying interaction means associated with each concerned user;
retrieving the information needed to establish interactions via the identified interaction means;
checking the availability of the identified interaction means;
caching inside the user's terminal retrieved information related to said identified users' available interaction means;

As an illustrative example, a user “x” who shares a workspace with the members of his or her work team “A”, will have information (name, e-mail address, telephone number, user ID, for example) regarding every other user “y”, who is not a member of the team “A”, who has access or edited data located within that workspace. This is done for the purpose of anticipating a potential interaction between the user “x” and the user “y”.

A user “x” who, according to the aggregated interactions, will take part in a teleconference whose members he or she does not know, will have the information concerning the participants of that conference, thereby facilitating an interaction if one were to arise. If the user “x” wishes to interact with a user “b”, who is a member of that teleconference, he or she must simply run a search on the name of he user “b”. The list of interaction means via which he or she may interact a that moment with user “b” will be displayed to him or her.

To achieve this, the processing module 51 regularly queries either the interaction means (calendar or e-mail server, for example) associated with the user “x” directly, or the tools for managing these means (a presence server or access manager, for example) in order to:
identify any user “y” concerned by interactions related to the user “x”:

who posted a comment on the blog of user “x”, who accessed or edited a workspace in which user “x” is a member, or who will participate with the user “x” in a conference, for example;
identify the list of interaction means available to the user “y” as well as the identifiers, or more generally speaking, the information needed to establish an interaction via these interaction means of drawing from, for example, his or her public user profile (blog, personal website, instant messaging tool), or his or her e-mail server, or subsequent to a step of authentication with the server, for example;
cache the list of identified “interaction means-identifier(s)” pairs,
check the availability of the identified interaction means: regularly updating the list of “interaction means-identifier(s)” pairs (instant messaging-user ID, shared workspace-account, e-mail-e-mail address, personal website-URL, for example) related to the user “y” in order to index the list of interaction means available (logged in/out in an instant messaging service, telephone reachable/not reachable, for example);

In one variant, a notification may be displayed via the module 52 to the user “x” in order to confirm/ignore/postpone the caching of the information related to the user “y”.

It should be noted that the user may have more than one identifier in one interaction means (telephone-multiple telephone numbers, instant messaging-multiple user IDs, for example)

Preferentially, a finite list of interaction means preferred for use in interaction is specified.

Furthermore. the processing module 51 makes it possible to:
filter user interactions (ignoring interactions, transmitting to the presentation module 52 at most n interactions for each unit of time. for example);
organizing user interactions based on different criteria;
assigning priorities to the different types of interactions.

The presentation module 52 is meant to present the aggregated interactions to the user. This presentation may be done via:
an oral interface enabling the audio/video playback of user interactions, by using the module VoiceXML, for example, or
graphical interface comprising icons, windows, shortcuts, and configuration menus of the processing module 51.

It should be noted that the client interfaces 111, 112, 113, the aggregator 50, the processing module 51, and the presentation module 52 form the client tool 5 of the user interaction summarizer.

In order to accelerate the processing of interaction data, the aggregator 50 is provided with a database 501 for storing, at least temporarily, the most commonly used data. This database 501 makes it possible to:
cache the interaction means, as well as the information enabling and interaction via these interaction means associated with users identified by the processing module 51;
accelerate the processing carried out by the processing module 51, in order to find data more quickly;
quickly respond to user requests sent from the presentation module 52;
store at least part of the interaction data (contacts, names, identifiers, telephone numbers, and addresses, for example).

Advantageously. the database 501 is equipped with a means of indexing, facilitating the manipulation of the database 501's content.

According to one embodiment of the presentation module 52, illustrated by FIG. 2, a graphical interface 100 distributed across a plurality of fields 102, 103, 104 may be adopted. The fields 102, 103, 104 concerned, for example, future interactions, ongoing interactions, and past interactions. The ongoing interactions may designate, for example:
the interactions which are in the course of execution (a telephone communication in course using a softphone, or an e-mail not yet read, for example);
the interactions that have already taken place or which will take place today, this morning, or this week, for example;
the future interactions which are the ones that will take place the following moment, next hour, tomorrow, or the following week, for example.

In other words, the user specifies the scope of these fields of interaction by altering the resolution of the time axis.

In one variant, the fields 102, 103, 104 may designate:
fields distributed based on their degrees of priority: high, medium, and low, for example;
interactive, informative, and alert field of interaction;
interactions to be carried out, in the course of being carried out, or already carried out;
a business approach to the fields: clients, suppliers, and work teams, for example.

The graphical interface 100 is equipped with a tool menu 101 comprising, for example, functions making it possible to:
delete/edit the notification of an interaction;
sort the user interactions based on different criteria (date, contact, type of interaction, source of the interaction, for example);
perform a search of interactions by field, or a search on all interactions.

The notification 140 of an interaction comprises descriptive elements 120 and active elements 130.

According to one embodiment, the descriptive elements 120 comprise the following data in combination:
user(s) concerned(s) by this interaction: Last name, first name, user ID, group, workgroup, for example;
the interaction means 10, 20, 30 which are the sources of this interaction notification: Gmail, MY Teamwork, forum A, blog C. workspace D, schedule, calendar, for example;
object of the interaction: object of the e-mail, object of the comment, call, missed call, or voice message, for example;
the date when this interaction was received;
the time elapsed/remaining to begin/complete an interaction; time remaining to attend a meeting, time elapsed in a voice communication, for example;
the existence of a complement associated with that interaction: an attachment or comment, for example.

The active elements 130 comprise the following elements:
the interaction tools: telephone identifier, e-mail, user ID; link to a website, linked to a workspace, for example;
the interaction action: reply, reply to all, call, explore, or visit, for example;
actions to be applied to that interaction: open, read, delete, confirm, more details, move to, ignore, stop, mark as done/read/seen/completed, for example.

It should be noted that the active interaction means offered to the user make it possible to directly access the interaction applications. For example, if the user decides to call a member within a certain text-based interaction (an e-mail, for example), by clicking on an active element 130 that designates a softphone, the user will automatically be put in communication with that member via the softphone. It is dear that an interaction application will automatically be launched, if it has not already been, once it is called by way of an active element 130.

The interaction means presented to the user correspond to the interaction means identified by the processing module 51.

Preferentially, the descriptive elements 120 comprise the name of at least one user (the called user, the calling user, the recipient, or the coworker, for example) related to the presented interaction.

Advantageously, the present invention encourages interaction between users by:
detecting information concerning users who share at least one remote interaction means 10, 20, 30 or members of a single future interaction; and then
storing these identifiers within the database 501 or directly proposing them to the user via the presentation module 52.

According to another embodiment, a first aggregator associated with the local interaction means and a second aggregator associated with the remote interaction means may both be provided. The second aggregator cooperates with the first one only if the user's terminal has access to at least one network.

Given that the aggregated interactions only concern one user, one account is provided for each user. A user account is configured by:
an identifier and a password;
personal data: e-mail addresses, telephone numbers, lists of contacts, address books, user IDs, forums, personal websites, and calendars, for example;
other data: domain name, workgroup, mailing list, and shared calendar, for example.

This data may be entered directly via a graphical interface, or imported from other databases or applications, or automatically collected from the user's terminal or from servers 1, 2, 3 (IP address, network links, and domain name, for example). It is clear that the data associated with each user is protected, as well as exportable to other applications.

The invention particularly applies to a situation in which the user is a machine, such as a robot configured to interact with a plurality of machines and/or users.

One account per user group is also provided. This account affects all interactions associated with all members of the user group.

Preferentially, the client tool 5 of the user interaction summarizer is provided with an application programming interface 53 (API), enabling it to interact with other applications 6 which are external to it. The application programming interface 53 makes it possible to:
return part of the content of the mobile presentation 52 (a field 102, 103, 104, the notification of an interaction, for example, a piece of data from an interaction notification);
access a set of functions supported by the presentation module 52 or by the processing module 51;
unifying access to the client tool 5 of the user interaction summarizer;
controlling the client tool 5 of the user interaction summarizer.

The method just described exhibits a certain number of advantages. In particular, it makes it possible to:
aggregate user interactions;
apply processing to these aggregations;
centralize the presentation of user interactions;
encourage user interaction.

The present invention relates to any environment of a user terminal operating in graphical or voice mode, such as a PDA (Personal Digital Assistant), a computer, a mobile telephone, or any other user terminal equipped with an operating system. It is also important to note that the implementation of the present invention is independent of the programming language(s) that is/are used (C, C++, .NET, Ajax, java, flash, Techno C, for example).

It should also be noted that the term “user interaction” here covers any interaction that relates to a user, without he or she necessarily being the author of that interaction or logged in to the interaction means at the time that the interaction took place. For example, a change made to the content of a shared calendar is an interaction associated with each of the users subscribed to that calendar, whether or not they are logged in at the time of the change.

1. A method for the synthesis of a user's interactions associated with a user, wherein it comprises the following steps:
aggregating a user's interactions from interaction means (10, 20, 30, 41, 40) associated with a user;
identifying the users concerned by said actions;
identifying the interaction means associated with each concerned user;
recovering the information received to establish at least one interaction via the identified interaction means;
checking the availability of the identified interaction means;
caching inside the user's terminal retrieved information related to said identified users' available interaction means;
presenting interaction notifications to the user.

2. A method according to claim 1, wherein the aggregation of interactions is carried out based on remote means of interaction (10, 20, 30) associated with the user.

3. A method according to claim 1, wherein the aggregation of interactions is carried out based on local interaction means (41, 40, 30) associated with the user.

4. A method according to any one of the preceding claims, wherein the aggregation of user interactions is carried out via interfaces appropriate to the interaction means (10, 20, 30; 41, 40).

5. A method according to claim 1, wherein the aggregation of user interactions takes into account intermediary interaction means (110).

6. A method according to claim 1, wherein the user retrieves information related to other users having a common interaction means with him or her.

7. A method according to claim 1, wherein an interaction notification (140) comprises descriptive elements (120) and active elements (130).

8. A method according to claim 7, wherein the active elements are associated with interaction means (10, 20, 30; 40, 41).

9. A method according to claim 1, wherein the information related to the user interactions is temporarily saved in a database (501).

10. A summarizer of user interactions associated with a user, wherein it comprises:
an aggregator (50) of user interactions drawn from interaction means associated with the user;
a user interaction processing module (51);
a user interaction processing module (52);

11. A summarizer of user interactions according to claim 10, wherein it comprises an application programming interface (53).

12. A summarizer of user interactions according to claim 10, wherein the aggregator (50)-server (10, 20, 30) link comprises client interfaces (111, 112, 113) and server interfaces (11, 12, 13).

13. A summarizer of user interactions according to claim 10, wherein the aggregator (50) takes into account the intermediary interaction means (110).

14. A summarizer of user interactions according to claim 10, wherein it comprises a database (501) for temporarily saving information related to the interactions.

15. A summarizer according to claim 10, wherein the processing module makes it possible to:
identify the users concerned by these interactions;
identify the interaction means associated with each concerned user;
retrieve the information needed to establish at least one interaction via the identified interaction means;
check the availability of the identified interaction means;
caching inside the user's terminal retrieved information related to said identified users' available interaction means;

16. A computer program product implemented on a memory medium, which may be implemented within a computer processing unit, and comprises instructions to implement a method according to claim 1.
